(19) United States
(12) Patent Application Publication
(10) Pub. No.: US 2014/0255771 A1
(43) Pub. Date: Sep. 11, 2014

(54) POSITIVE ACTIVE MATERIAL COMPOSITION FOR RECHARGEABLE LITHIUM BATTERY, POSITIVE ELECTRODE FOR RECHARGEABLE LITHIUM BATTERY INCLUDING SAME AND RECHARGEABLE LITHIUM BATTERY INCLUDING SAME

(71) Applicant: Samsung SDI Co., Ltd., Yongin-si (KR)

(72) Inventors: Seung-Hun Han, Yongin-si (KR); Myung-Duk Lim, Yongin-si (KR); Chae-Woong Cho, Yongin-si (KR)

(21) Appl. No.: 13/931,541

(22) Filed: Jun. 28, 2013

(30) Foreign Application Priority Data
Mar. 6, 2013 (KR) 10-2013-0023994

(51) Int. Cl. H01M 4/485; H01M 4/66; H01M 4/134

(52) U.S. Cl. CPC H01M 4/485; H01M 4/134; H01M 4/661
USPC 429/188; 252/519.15; 252/519.14; 429/211

(57) ABSTRACT

Disclosed are a positive active material composition for a rechargeable lithium battery, a positive electrode for a rechargeable lithium battery including the same, and a rechargeable lithium battery including the positive electrode. The positive active material composition for a rechargeable lithium battery includes a nickel-based positive active material having pH of greater than or equal to about 11; V₂O₅; an aqueous binder, and a conductive material.

### INCORPORATION BY REFERENCE TO RELATED APPLICATIONS

Any and all priority claims identified in the Application Data Sheet, or any correction thereto, are hereby incorporated by reference under 37 CFR 1.57. For example, this application claims priority to and the benefit of Korean Patent Application No. 10-2013-0023994 filed on Mar. 6, 2013 in the Korean Intellectual Property Office, the disclosure of which is incorporated in its entirety herein by reference.

### BACKGROUND

1. Field

This disclosure relates to a positive active material composition for a rechargeable lithium battery, a positive electrode for a rechargeable lithium battery including the same, and a rechargeable lithium battery including the same.

2. Description of the Related Art

Rechargeable lithium batteries have recently drawn attention as a power source for small portable electronic devices. They typically use an organic electrolyte and thereby have twice or more discharge voltage than that of a conventional battery using an alkali aqueous solution and accordingly, have high energy density.

Lithium-transition element composite oxides being capable of intercalating lithium such as LiCoO₂, LiMn₂O₄, LiNi₁₋ₓCoₓO₂ (0<x<1), and the like have been studied as positive active materials for rechargeable lithium batteries.

Rechargeable lithium batteries typically use carbon-based materials such as artificial graphite, natural graphite, and hard carbon, which can intercalate and deintercalate lithium ions as a negative active material.

### SUMMARY

One embodiment provides a positive active material composition for a rechargeable lithium battery having improved high rate capability and cycle-life characteristic.

Another embodiment provides a positive electrode for a rechargeable lithium battery including a positive active material composition as disclosed and described herein.

Still another embodiment provides a rechargeable lithium battery including a positive electrode as disclosed and described herein.

According to one embodiment, a positive active material composition for a rechargeable lithium battery may include a nickel-based positive active material; V₂O₅; and an aqueous binder. In some embodiments, the nickel-based positive active material may have a pH of greater than or equal to about 11.

In some embodiments, the nickel-based positive active material may be a compound represented by the following Formula 1 or 2.

LiₓMO_{2-z}L_{z} Formula 1

In Formula 1, M is M′₁₋ₖAₖ (M′ is Ni_{1-d-e}Mn_{d}Coₑ, 0.3≦d+e≦0.7, 0.1≦e≦0.4, A is a dopant, and 0≦k<0.05),

L is F (fluorine), S (sulfur), P (phosphorus), or a combination thereof,

0.95≦x≦1.05, and

0≦z≦2.

LiₓNi_{y}T_{1-y}O_{2-z}L_{z} Formula 2

In Formula 2, T is Al, Ni, Co, Mn, Cr, Fe, Mg, Sr, a rare earth element, or a combination thereof,

L is F (fluorine), S (sulfur), P (phosphorus), or a combination thereof,

0.95≦x≦1.05,

0.3≦y≦0.7, and

0≦z≦2.

In some embodiments, the aqueous binder may be selected from an acryl-based copolymer, an ethylenepropylene copolymer, polyethyleneoxide, polyvinylpyrrolidone, polyepichlorohydrine, polyphosphazene, polyacrylonitrile, polystyrene, an ethylenepropylenediene copolymer, polyvinylpyridine, chlorosulfonated polyethylene, a polyester resin, an acrylic resin, a phenolic resin, an epoxy resin, polyvinylalcohol, carboxylmethyl cellulose, and a combination thereof.

In some embodiments, the V₂O₅ may be included in an amount ranging from about 0.1 parts by weight to 5 parts by weight based on 100 parts by weight of the positive active material.

The positive active material composition may have pH of greater than or equal to about 7 and less than about 11.

Some embodiments provide a positive electrode for a rechargeable lithium battery including a current collector; and a positive active material layer formed by disposing the positive active material composition on the current collector. The current collector may be Al.

Some embodiments provide a rechargeable lithium battery includes a positive electrode including the positive active material composition; a negative electrode including a negative active material; and an electrolyte including an organic solvent and a lithium salt.

Hereinafter, further embodiments of this disclosure will be described in the detailed description.

The positive active material composition according to the present disclosure may suppress internal resistance increase caused by corrosion of a current collector and thus, may provide a battery having high rate capability and cycle-life characteristic.

### BRIEF DESCRIPTION OF THE DRAWINGS

FIG. 1 is a schematic view showing the structure of a rechargeable lithium battery according to one embodiment.

FIG. 2 is a SEM photograph showing the surface of a positive electrode according to Example 1.

FIG. 3 is a SEM photograph showing the surface of a positive electrode according to Comparative Example 1.

### DETAILED DESCRIPTION

Exemplary embodiments will hereinafter be described in detail. However, these embodiments are exemplary, and this disclosure is not limited thereto.

Some embodiments provide a positive active material composition for a rechargeable lithium battery includes a nickel-based positive active material having pH of greater than or equal to about 11; V₂O₅; an aqueous binder, and a conductive material.

In some embodiments, the V₂O₅ is a strong oxidant and thus, may suppress corrosion of a positive current collector caused by basification of the positive active material composition of slurry type used in a positive electrode preparation.

In some embodiments, the V₂O₅ may be included in an amount of range from about 0.1 parts to about 5 parts by weight based on 100 parts by weight of the positive active material. When the V₂O₅ is included in an amount of less than about 0.1 parts by weight, a current collector, particularly an Al current collector, may be oxidized and corroded. On the contrary, when the V₂O₅ is included in an amount of greater than about 5 parts by weight, capacity density per gram may be decreased, as the volume of the V₂O₅ is increased.

In some embodiments, the V₂O₅ may be included in a positive active material composition and thus, may suppress corrosion of a positive current collector and simplify an electrode manufacturing process in an economical manner. When V₂O₅ is coated on a current collector, the process for coating may be complicated and it may be difficult to uniformly coat affording an unevenness of current density, promoting deterioration in a particular region and thus, deteriorating battery performance.

In some embodiments, the positive active material composition may be usefully applied to a positive electrode for a rechargeable lithium battery and particularly, a positive electrode using an aqueous binder. However, a rechargeable lithium battery using the aqueous binder may have an internal resistance increase problem due to the following reason. A positive active material slurry including a positive active material, an aqueous binder, a conductive material, and a solvent may be strongly basic (pH 11 to 14) from LiCO₃, LiOH, and the like remaining after preparation of the positive active material slurry. When this strongly basic positive active material slurry is coated on a current collector and particularly, an Al current collector, the Al current collector may be corroded due to the high pH of the positive active material slurry and thus, generate H₂ gas. Accordingly, a large number of pin holes may be formed on an electrode causing increased internal resistance of the electrode. The following Reaction Scheme illustrated a reaction generating H₂ gas which in turn generates the pin holes.

When the Al current collector has an Al₂O₃ film on the surface, the oxide film may suppress a reaction according to the following Reaction Scheme 1 of the Al current collector with water in a neutral aqueous solution.

2Al+6H₂O→2Al(OH)₃+3H₂↑ Reaction Scheme 1

However, the oxide film reacts according to the following Reaction Schemes 2 and 3 under alkali conditions and thus, keeps being dispersed as Al ions in the alkali aqueous solution. The dispersed Al ions can react with water and generate H₂ gas, which may form a pin hole on the surface of the electrode.

Al₂O₃+H₂O+2OH−→2AlO₂−+2H₂O Reaction Scheme 2

2Al+2OH−+6H₂O→2[Al(OH)₄]⁻+3H₂ Reaction Scheme 3

According to one embodiment, a positive active material composition includes a strong oxidant, V₂O₅, and thus, suppresses the reaction according to Reaction Scheme 1. The V₂O₅ may react with Al metal or Al ions to form Al₂O₃. For example, the V₂O₅ may react according to the following Reaction Scheme 4.

2Al+V₂O₅→Al₂O₃+VO₂ Reaction Scheme 4

The positive active material composition according to one may be suppressed from generation of H₂, since the V₂O₅ suppresses dispersion of Al ions and resultantly, corrosion of the current collector.

In particular, the suppression effect may be maximized when a nickel-based active material having pH of greater than or equal to about 11 is used as a positive active material. When the positive active material itself has pH greater than or equal to about 11, the reaction according to Reaction Scheme 1 may actively occur and severely corrode the current collector, which is effectively suppressed by adding V₂O₅. When the positive active material has lower pH, for example, a cobalt-based positive active material such as LiCoO₂ and the like, a manganese-based positive active material such as LiMn₂O₄, LiMnO₂, and the like, LiFePO₄, or the like, the reaction according to Reaction Scheme 1 is not as severe, and thus, the addition of V₂O₅ during the fabrication of a positive electrode may have a little effect.

In addition, the V₂O₅ has excellent electrical conductivity and thus, may not work as a resistance component in the positive electrode. Accordingly, the addition of the V₂O₅ may not deteriorate charge and discharge characteristic. The V₂O₅ has a lower isoelectric point (IEP) ranging from about 1 to about 2 than that of MoO₃ (IEP: 2.5) and thus, may prevent corrosion of the positive electrode even though even used in a small amount.

Examples of a nickel-based positive active material having pH of greater than or equal to about 11 may be a compound represented by the following Formula 1 or 2.

LiₓMO_{2-z}L_{z} Formula 1

In Formula 1, M is M′₁₋ₖAₖ (M′ is Ni_{1-d-e}Mn_{d}Coₑ, 0.3≦d+e≦0.8, 0.1≦e≦0.4, A is a dopant, and 0≦k≦0.05. Herein, examples of A may be an element selected from B (boron), Ca, Zr, S, F, P, Bi, Al, Mg, Zn, Sr, Cu, Fe, Ga, In, Cr, Ge, or Sn.

L is F (fluorine), S (sulfur), P (phosphorus), or a combination thereof,

0.95≦x≦1.05, and

0≦z≦2.

LiₓNi_{y}T_{1-y}O_{2-z}L_{z} Formula 2

In Formula 2, T is Al, Ni, Co, Mn, Cr, Fe, Mg, Sr, a rare earth element, or a combination thereof,

L is F (fluorine), S (sulfur), P (phosphorus), or a combination thereof,

0.95≦x≦1.05,

0.3≦y≦0.7, and

0≦z≦2.

The nickel-based positive active material may have pH of about 11 to about 14.

In some embodiments, the positive active material composition may have pH of greater than or equal to about 7 and less than about 11. When the positive active material composition has pH of greater than or equal to about 11, a current collector is corroded and thus, increases resistance of the electrode and deteriorates battery performance. On the other hand, when the positive active material composition has pH of less than about 7, a binder therein may have damage.

According to one embodiment, the V₂O₅ and the positive active material are used in an amount of about 90 wt % to 98 wt % based on 100 wt % of the entire amount of the positive active material composition. When the V₂O₅ and the positive active material are used within the range, maximum capacity in a battery having the same volume may be realized.

In some embodiments, the aqueous binder may be selected from an acryl-based copolymer, an ethylenepropylene copolymer, polyethyleneoxide, polyvinylpyrrolidone, polyepichlorohydrine, polyphosphazene, polyacrylonitrile, polystyrene, an ethylenepropylenediene copolymer, polyvinylpyridine, chlorosulfonated polyethylene, a polyester resin, an acrylic resin, a phenolic resin, an epoxy resin, polyvinylalcohol, carboxylmethyl cellulose, and a combination thereof. This aqueous binder may use water as a solvent and a dispersion medium and thus, be environmentally-friendly.

In some embodiments, the aqueous binder may be used in an amount ranging from about 1 wt % to about 5 wt % based on 100 wt % of the positive active material composition. When the aqueous binder is used within this range, active material particles may not only be adhered together but an active material may also be firmly attached to a current collector without deteriorating conductivity of the substrate and capacity.

Any electrically conductive material may be used as the conductive material, unless it causes a chemical change. Examples of the conductive material include a carbon-based material such as natural graphite, artificial graphite, carbon black, acetylene black, ketjen black, a carbon fiber, and the like; a metal-based material such as metal powder or metal fiber including copper, nickel, aluminum, silver, and the like; a conductive polymer such as polyphenylene derivative; or a mixture thereof. In some embodiments, the conductive material may be used in an amount ranging from about 1 wt % to about 5 wt % based on 100 wt % of the positive active material composition. When the conductive material is included within the range, battery capacity may not only be maintained but electrical conductivity may also be appropriately improved.

According to one embodiment, the positive active material composition may further include a cellulose-based compound as a thickener to impart viscosity. In some embodiments, the cellulose-based compound may include one or more of carboxylmethyl cellulose, hydroxypropylmethyl cellulose, methyl cellulose, or an alkali metal salt thereof. In some embodiments, the carboxylmethyl cellulose may be a material that works as a binder as well as a thickener. In some embodiments, the alkali metal may be Na, K, or Li. Such a thickener may be used in an amount ranging from about 0.1 parts by weight to about 3 parts by weight based on 100 parts by weight of the positive active material.

Another embodiment provides a positive electrode for a rechargeable lithium battery that includes a current collector and a positive active material layer formed by disposing the positive active material composition on the current collector. The current collector may be Al.

In some embodiments, the positive electrode may be manufactured in a method which includes mixing a positive active material, an aqueous binder, and a conductive material in a solvent to prepare a positive active material slurry and coating the slurry on a current collector. In some embodiments, the solvent may be water. In this way, the positive electrode is fabricated using water instead of an organic solvent such as very toxic N-methylpyrrolidone to prepare the positive active material slurry and thus, is not toxic to a human body and decreases a cost. In addition, this positive electrode may suppress internal resistance increase of a rechargeable lithium battery and bring about excellent high-rate and cycle-life characteristics.

Another embodiment provides a rechargeable lithium battery including the positive electrode; a negative electrode including a negative active material; and an electrolyte.

In some embodiments, the negative electrode includes a current collector and a negative active material layer disposed on the current collector, and the negative active material layer includes a negative active material.

In some embodiments, the negative active material may include a material that reversibly intercalates/deintercalates lithium ions, lithium metal, a lithium metal alloy, a material being capable of doping/dedoping lithium, transition metal oxide, or a combination thereof.

In some embodiments, the material that reversibly intercalates/deintercalates lithium ions may be a carbon material. In some embodiments, the carbon material may be any generally-used carbon-based negative active material in a lithium ion rechargeable battery. Examples of the carbon material include crystalline carbon, amorphous carbon, and mixtures thereof. In some embodiments, the crystalline carbon may be non-shaped, or sheet, flake, spherical, or fiber shaped natural graphite or artificial graphite. In some embodiments, the amorphous carbon may be a soft carbon, a hard carbon, a mesophase pitch carbonized product, fired coke, and the like.

Examples of the lithium metal alloy include lithium and a metal selected from Na, K, Rb, Cs, Fr, Be, Mg, Ca, Sr, Si, Sb, Pb, In, Zn, Ba, Ra, Ge, Al, and Sn.

Examples of the material being capable of doping/dedoping lithium include Si, a Si—C composite, SiOₓ (0<x<2), a Si-Q alloy (wherein Q is an element selected from an alkali metal, an alkaline-earth metal, a Group 13 element, a Group 14 element, a Group 15 element, a Group 16 element, a transition element, a rare earth element, and a combination thereof, and not Si), Sn, SnO₂, a Sn—R alloy (wherein R is an element selected from an alkali metal, an alkaline-earth metal, a Group 13 element, a Group 14 element, a Group 15 element, a Group 16 element, a transition element, a rare earth element, and a combination thereof, and not Sn), and the like. At least one of these materials may be mixed with SiO₂. In some embodiments, the elements, Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

In some embodiments, the transition elements oxide may be vanadium oxide, lithium vanadium oxide, or lithium titanium oxide.

In the negative active material layer, the negative active material may be included in an amount of about 95 wt % to about 99 wt % based on the total weight of the negative active material layer.

In some embodiments, the negative active material layer may include a binder, and optionally a conductive material. In the negative active material layer, the binder may be included in an amount of about 1 wt % to about 5 wt % based on total weight of the negative active material layer. When the negative active material layer includes a conductive material, the negative active material layer includes about 90 wt % to about 98 wt % of the negative active material, about 1 wt % to about 5 wt % of the binder, and about 1 wt % to about 5 wt % of the conductive material.

The binder improves binding properties of negative active material particles with one another and with a current collector. In some embodiments, the binder may be a non-aqueous binder, an aqueous binder, or a combination thereof.

In some embodiments, the non-aqueous binder includes polyvinylchloride, carboxylatedpolyvinylchloride, polyvinylfluoride, ethylene oxide-containing polymer, polyvinylpyrrolidone, polyurethane, polytetrafluoroethylene, polyvinylidene fluoride, polyethylene, polypropylene, polyamideimide, polyimide, or a combination thereof.

In some embodiments, the aqueous binder may include a rubber-based binder or a polymer resin binder.

In some embodiments, the rubber-based binder may be selected from a styrene-butadiene rubber, an acrylated styrene-butadiene rubber (SBR), an acrylonitrile-butadiene rubber, an acrylic rubber, a butyl rubber, a fluorine rubber, and a combination thereof.

In some embodiments, the polymer resin binder may be selected from polyethylene, polypropylene, an ethylene propylene copolymer, polyethylene oxide, polyvinylpyrrolidone, polyepichlorohydrine, polyphosphazene, polyacrylonitrile, polystyrene, an ethylene propylene diene copolymer, polyvinylpyridine, chlorosulfonated polyethylene, latex, a polyester resin, an acrylic resin, a phenolic resin, an epoxy resin, a polyvinyl alcohol, and a combination thereof.

When the water-soluble binder is used as a negative electrode binder, a cellulose-based compound may be further used to provide viscosity as a thickener. The cellulose-based compound includes one or more of carboxylmethyl cellulose, hydroxypropylmethyl cellulose, methyl cellulose, or alkali metal salts thereof. In some embodiments, the alkali metal may be Na, K, or Li. The thickener may be included in an amount of about 0.1 parts to about 3 parts by weight based on 100 parts by weight of the negative active material.

The conductive material is included to improve electrode conductivity. Any electrically conductive material may be used as a conductive material unless it causes a chemical change. Examples of the conductive material include a carbon-based material such as natural graphite, artificial graphite, carbon black, acetylene black, ketjen black, a carbon fiber, and the like; a metal-based material of metal powder or metal fiber including copper, nickel, aluminum, silver, and the like; conductive polymers such as polyphenylene derivatives; or a mixture thereof.

In some embodiments, the current collector may be selected from a copper foil, a nickel foil, a stainless steel foil, a titanium foil, a nickel foam, a copper foam, a polymer substrate coated with a conductive metal, and a combination thereof.

In some embodiments, the electrolyte includes an organic solvent and a lithium salt.

The organic solvent serves as a medium of transmitting ions taking part in the electrochemical reaction of the battery.

In some embodiments, the organic solvent may include a carbonate-based, ester-based, ether-based, ketone-based, alcohol-based, or aprotic solvent. The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like, and the ester based solvent may include methyl acetate, ethyl acetate, n-propyl acetate, dimethyl acetate, methyl propionate, ethyl propionate, γ-butyrolactone, decanolide, valerolactone, mevalonolactone, caprolactone, and the like. The ether-based solvent may include dibutyl ether, tetraglyme, diglyme, dimethoxyethane, 2-methyltetrahydrofuran, tetrahydrofuran, and the like, and the ketone-based solvent may include cyclohexanone and the like. In some embodiments, the alcohol-based solvent may include ethyl alcohol, isopropyl alcohol, and the like, and examples of the aprotic solvent include nitriles such as R—CN (where R is a C2 to C20 linear, branched, or cyclic hydrocarbon that may include a double bond, an aromatic ring, or an ether bond), amides such as dimethylformamide, dioxolanes such as 1,3-dioxolane, sulfolanes, and the like.

In some embodiments, the organic solvent may be used singularly or in a mixture. When the organic solvent is used in a mixture, the mixture ratio can be controlled in accordance with a desirable battery performance.

In some embodiments, the carbonate-based solvent may include a mixture with a cyclic carbonate and a linear carbonate. In some embodiments, the cyclic carbonate and the linear carbonate are mixed together in a volume ratio of about 1:1 to about 1:9. When the mixture is used as an electrolyte, it may have enhanced performance.

In addition, the non-aqueous organic electrolyte may further include an aromatic hydrocarbon-based solvent as well as the carbonate-based solvent. In some embodiments, the carbonate-based solvents and the aromatic hydrocarbon-based solvents may be mixed together in a volume ratio of about 1:1 to about 30:1.

In some embodiments, the aromatic hydrocarbon-based organic solvent may be represented by the following Chemical Formula 3.

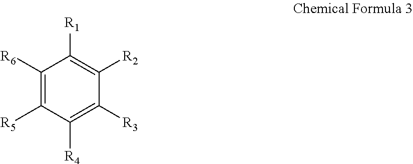

In Chemical Formula 1, R₁ to R₆ are the same or different and are selected from hydrogen, a halogen, a C1 to C10 alkyl group, a haloalkyl group, and a combination thereof.

In some embodiments, the aromatic hydrocarbon-based organic solvent may include one selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

In some embodiments, the electrolyte may further include vinylene carbonate or an ethylene carbonate-based compound represented by the following Chemical Formula 4 to improve cycle life.

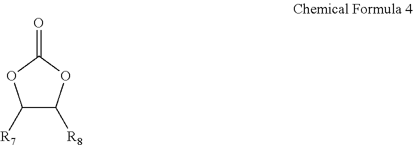

In Chemical Formula 4, R₇ and R₈ are each independently hydrogen, a halogen, a cyano (CN) group, a nitro (NO₂) group, or a C1 to C5 fluoroalkyl group, provided that at least one of R₇ and R₈ is a halogen, a nitro (NO₂) group, or a C1 to C5 fluoroalkyl group, and R₇ and R₈ are not simultaneously hydrogen.

In some embodiments, the ethylene carbonate-based compound includes difluoroethylene carbonate, chloroethylene carbonate, dichloroethylene carbonate, bromoethylene carbonate, dibromoethylene carbonate, nitroethylene carbonate, cyanoethylene carbonate, fluoroethylene carbonate, and the like. The amount of the additive for improving cycle life may be flexibly used within an appropriate range.

The lithium salt is dissolved in an organic solvent, supplies a battery with lithium ions, basically operates the rechargeable lithium battery, and improves transportation of the lithium ions between positive and negative electrodes. Such a lithium salt may include at least one supporting salt selected from LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) (where x and y are natural numbers of 1 to 20, respectively), LiCl, LiI, and LiB(C₂O₄)₂ (lithium bis(oxalato)borate). In some embodiments, the lithium salt may be used in a concentration ranging from about 0.1 M to about 2.0 M. When the lithium salt is included at the above concentration range, an electrolyte may have optimal electrolyte conductivity and viscosity, and may thus have enhanced performance and effective lithium ion mobility.

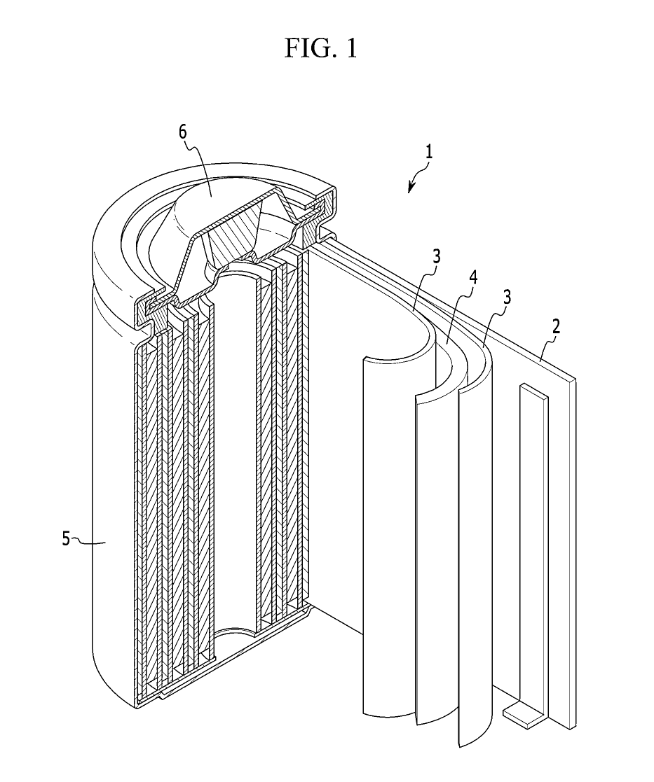

In some embodiments, the rechargeable lithium battery may further include a separator between the negative electrode and the positive electrode, as needed. Examples of a suitable separator material include polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator. As illustrated in FIG. 1, the rechargeable lithium battery 1 includes a battery case 5 including a positive electrode 2, a negative electrode 4, and a separator 3 interposed between the positive electrode 2 and negative electrode 4, an electrolyte impregnated therein, and a sealing member 6 sealing the battery case 5. In some embodiments, the battery case 5 may be a cylindrical, rectangular, or thin-film type. For example, the lithium battery 1 may be a thin-film type battery. In some embodiments, the lithium battery 1 may be a lithium-ion battery.

Hereinafter, examples of the present invention and comparative examples are described. These examples, however, are not in any sense to be interpreted as limiting the scope of the invention.

### EXAMPLES

### Example 1

Li_{1.05}Ni_{0.5}Co_{0.2}Mn_{0.3}O₂ (100 g) having pH 11.2 as a positive active material, acetylene black (2 g), carboxylmethyl cellulose (0.5 g), V₂O₅ (0.5 g), and water (20 g) were primarily mixed. Next, water (10 g) and an acryl-based copolymerization emulsion (AX-4069, Zeon Corporation, Tokyo Japan, 4 g at 40 wt %) were added to the primary mixture and secondarily mixed therewith, preparing a positive active material slurry composition.

The positive active material slurry composition was coated on an Al current collector, dried at 110° C. for 10 minutes, and compressed, fabricating a positive electrode (active mass density of 3.2 g/cc).

### Example 2

A positive electrode was fabricated according to the same method as Example 1 except for changing the amount of the V₂O₅ to 1.0 g.

### Example 3

A positive electrode was fabricated according to the same method as Example 1 except for using Li_{1.045}Ni_{0.8}Co_{0.15}Al_{0.05}O₂ (NCA) having pH 11.7 as a positive active material.

### Comparative Example 1

Li_{1.05}Ni_{0.5}Co_{0.2}Mn_{0.3}O₂ (100 g) as a positive active material, acetylene black (2 g), carboxylmethyl cellulose (0.5 g), and water (20 g) were primarily mixed. Then, water (10 g) and an acryl-based copolymerization emulsion (4 g, AX-4069) were added to the primary mixture and secondarily mixed, preparing a positive active material slurry composition.

The positive active material slurry composition was coated on an Al current collector, dried at 110° C. for 10 minutes, and compressed, fabricating a positive electrode.

### Comparative Example 2

A positive electrode was fabricated according to the same method as Example 1 except for using 0.5 g of MoO₃ instead of 0.5 g of V₂O₅.

### Comparative Example 3

A positive electrode was fabricated according to the same method as Example 1 except for using 1.0 g of MoO₃ instead of 0.5 g of the V₂O₅.

### Comparative Example 4

A positive electrode was fabricated according to the same method as Example 1 except for using Li_{1.045}Ni_{0.8}Co_{0.15}Al_{0.05}O₂ as a positive active material.

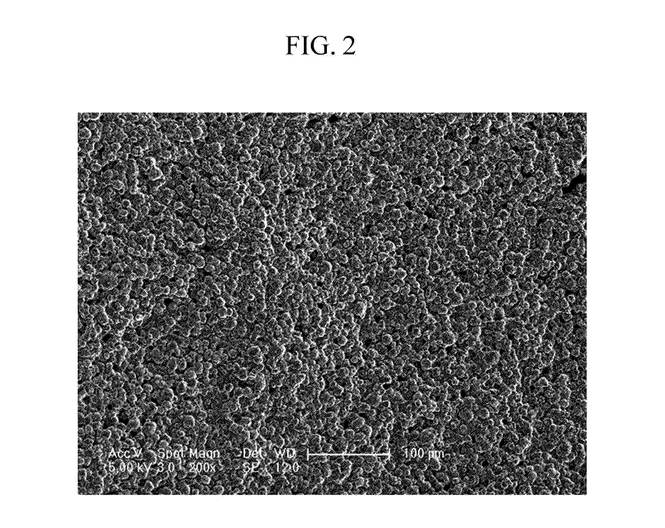

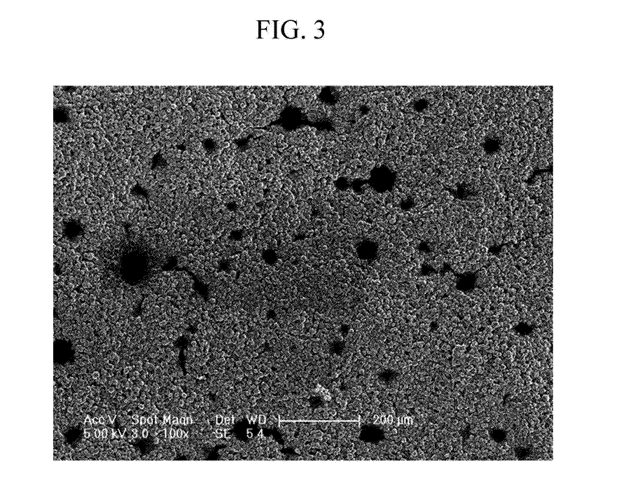

The positive electrodes according to Example 1 and Comparative Example 1 were analyzed by taking a SEM photograph on the surface of the electrodes. The results are respectively provided in FIGS. 2 and 3. As shown in FIG. 2, the positive electrode according to Example 1 maintained a dense and uniform surface, while the positive electrode according to Comparative Example 1 had a large number of pin holes as shown in FIG. 3.

The positive electrodes according to Examples 1 to 3 and Comparative Examples 1 to 4 were respectively combined with a negative electrode and an electrolyte, fabricating a rechargeable lithium battery cell. Herein, the negative electrode was fabricated by adding graphite (97.5 g, MAG-V4) and carboxylmethylcellulose (1 g) to water (50 g) and mixing them, adding a styrene-butadiene rubber binder (BM 400B, Zeon Corporation, Tokyo Japan, emulsion type, solvent: water, the content of solid: 40 wt %) and water (50 g) to the resulting mixture to prepare negative active material slurry, coating the slurry on a copper foil current collector, and then, drying it. The electrolyte was prepared by mixing ethylene carbonate, ethylmethyl carbonate, and diethyl carbonate in a volume ratio of 3:5:2 to prepare an organic solvent and dissolving 1.3M LiPF₆ therein.

The rechargeable lithium battery cells were 100 times charged at 0.5 C and discharged with 1.0 C. Then, capacity retentions of the rechargeable lithium battery cells by calculating a ratio of discharge capacity at the 100th cycle relative to the discharge capacity at the first cycle (100th discharge capacity/1 st discharge capacity)*100) were obtained. The results are provided in the following Table 1.

In addition, the positive electrodes according to Examples 1 to 4 and Comparative Examples 1 to 4 were allowed to stand in the air for 3 minutes and analyzed to determine if the positive electrodes were corroded or not. The results are provided in the following Table 1.

TABLE 1

| | Corrosion | Capacity retention % |
|---|---|---|
| Comparative Example 1 | Corrosion | 78.3 |
| Example 1 | x | 89.2 |
| Example 2 | x | 88.9 |
| Comparative Example 2 | Corrosion | 79.5 |
| Comparative Example 3 | x | 86.4 |
| Comparative Example 4 | Corrosion | 75.1 |
| Example 3 | x | 88.5 |

As shown in Table 1, the positive electrodes using V₂O₅ according to Examples 1 to 3 were not corroded, and the rechargeable lithium battery cells including the positive electrodes had excellent capacity retention. In contrast, the positive electrodes according to Comparative Examples 1, 2, and 4 were corroded, and thus, the rechargeable lithium battery cells including the positive electrodes had deteriorated capacity retention compared with those according to Examples 1 to 3. In addition, the rechargeable lithium battery cell according to Comparative Example 3 had no electrode corrosion but very low capacity retention.

In the present disclosure, the terms “Example” and “Comparative Example” are used arbitrarily to simply identify a particular example or experimentation and should not be interpreted as admission of prior art. While this disclosure has been described in connection with what is presently considered to be practical exemplary embodiments, it is to be understood that the invention is not limited to the disclosed embodiments and is intended to cover various modifications and equivalent arrangements included within the spirit and scope of the appended claims. Therefore, the aforementioned embodiments should be understood to be exemplary but not limiting the present invention in any way.

What is claimed is:

1. A positive active material composition for a rechargeable lithium battery, comprising:
a nickel-based positive active material having pH of greater than or equal to about 11;
V₂O₅;
an aqueous binder; and
a conductive material.

2. The positive active material composition for a rechargeable lithium battery of claim 1, wherein the nickel-based positive active material is represented by the following Formula 1 or the following Formula 2:
LiₓMO_{2-z}L_{z} Formula 1
wherein, M is M′₁₋ₖAₖ (M′ is Ni_{1-d-e}Mn_{d}Coₑ, 0.3≦d+e≦0.7, 0.1≦e≦0.4, A is a dopant, and 0≦k<0.05),
L is F (fluorine), S (sulfur), P (phosphorus), or a combination thereof,
0.95≦x≦1.05,
0≦z≦2,
LiₓNi_{y}T_{1-y}O_{2-z}L_{z} Formula 2
wherein, T is Al, Ni, Co, Mn, Cr, Fe, Mg, Sr, a rare earth element, or a combination thereof,
L is F (fluorine), S (sulfur), P (phosphorus), or a combination thereof,
0.95≦x≦1.05,
0.3≦y≦0.7, and
0≦z≦2.

3. The positive active material composition for a rechargeable lithium battery of claim 2, wherein A is B (boron), Ca, Zr, S, F, P, Bi, Al, Mg, Zn, Sr, Cu, Fe, Ga, In, Cr, Ge, or Sn.

4. The positive active material composition for a rechargeable lithium battery of claim 1, wherein the aqueous binder is selected from an acryl-based copolymer, ethylenepropylene copolymer, polyethyleneoxide, polyvinylpyrrolidone, polyepichlorohydrine, polyphosphazene, polyacrylonitrile, polystyrene, an ethylenepropylenediene copolymer, polyvinylpyridine, a chlorosulfonated polyethylene, a polyester resin, an acrylic resin, a phenolic resin, an epoxy resin, polyvinylalcohol, carboxylmethyl cellulose, and a combination thereof.

5. The positive active material composition for a rechargeable lithium battery of claim 1, wherein an amount of the V₂O₅ ranges from about 0.1 parts by weight to 5 parts by weight based on 100 parts by weight of the positive active material.

6. The positive active material composition for a rechargeable lithium battery of claim 1, wherein the positive active material composition has pH of greater than or equal to about 7 and less than about 11.

7. A positive electrode for a rechargeable lithium battery, comprising:
a current collector; and
a positive active material layer disposed on the current collector and including the positive active material composition of claim 1.

8. The positive electrode for a rechargeable lithium battery of claim 7, wherein the current collector is Al.

9. A rechargeable lithium battery, comprising:
a positive electrode comprising the positive active material composition of claim 1;
a negative electrode including a negative active material; and
an electrolyte including an organic solvent and a lithium salt.
